(19) United States
(12) Patent Application Publication
(10) Pub. No.: US 2016/0107101 A1
(43) Pub. Date: Apr. 21, 2016

(54) DEGASSING MODULE

(71) Applicant: Buerkert Werke GmbH, Ingelfingen (DE)

(72) Inventors: Cyril REITER, Kesseldorf (FR); Marco ZUERN, Westernhausen (DE)

(21) Appl. No.: 14/884,169

(22) Filed: Oct. 15, 2015

(30) Foreign Application Priority Data
Oct. 17, 2014 (DE) 202014104979.7

(51) Int. Cl. B01D 19/00

(52) U.S. Cl. CPC B01D 19/0036

(57) ABSTRACT

The invention relates to a degassing module (10) having a fluid inlet (34), a degassing component (12), a fluid outlet (36), and a vacuum pump (20). The degassing component (12) and the vacuum pump (20) are integrated to form a unit which includes a mounting interface (30) at which the fluid inlet (34) and the fluid outlet (36) are positioned.

The present invention relates to a degassing module having a fluid inlet, a degassing component, a fluid outlet, and a vacuum pump.

Degassing of fluids is known from the prior art (from EP 0 598 424 A2, for example). The degassing of a fluid is advantageous in particular when the fluid is to be analyzed and any gases present would disturb or distort the analysis.

A degassing module is of advantage specifically in microsystems engineering and in the analysis of extremely small amounts of liquids since an exact metering is indispensable here. Even a minute quantity of gas in a sample to be analyzed may result in inaccuracies because the quantity of gas will displace a liquid volume. But since a pump delivering the liquid to be examined delivers a volume flow, any amount of gas contained therein will have a negative effect on the amount of the actually delivered substance.

Furthermore, in microsystems engineering optical methods are often made use of for the detection of substances or constituents. In this case, too, even the smallest of gas particles or other dissolved gases will lead to a distortion of the measurement results since they influence the light traveling through or cause scattering. Any gas in the fluid to be analyzed has very serious consequences especially when the sample to be analyzed heats up or when the pressure which it is subjected to decreases because the gases contained in the fluid will then dissolve to a particularly great extent.

In generalized terms, the degassing component used for degassing is divided into two chambers which are separated from each other by a diaphragm. The fluid to be degassed flows through one of the chambers, and a vacuum is applied to the other chamber. This causes gases contained in the fluid to (at least partly) pass through the diaphragm and to be sucked off via the vacuum chamber. For the diaphragm, PTFE may be used, for example.

While the prior degassing components have a satisfactory effect, they are worthy of improvement with respect to their structure.

The invention provides a degassing module including a fluid inlet, a degassing component, a fluid outlet, and a vacuum pump, the degassing component and the vacuum pump being integrated to form a unit which includes a mounting interface at which the fluid inlet and the fluid outlet are positioned. The invention is based on the fundamental idea of integrating all of the components required for degassing the fluid, forming a unit which can be mounted as a finished module. This means that it is not necessary to establish any external hose connections or disconnect them again for disassembly or maintenance of specific components. Rather, when the degassing module is mounted, it is automatically made sure by means of the mounting interface that the fluid inlet and the fluid outlet are suitably connected, for example to an analysis module.

According to one configuration of the invention, provision is made that the mounting interface is formed by a side face of a housing of the degassing component. This minimizes the number of components required.

Preferably, provision may be made here that the vacuum pump is attached to the degassing component. In this configuration it is only necessary to attach the degassing component in a suitable manner by means of the mounting interface. In this way, the vacuum pump is automatically mounted as part of the degassing module.

According to an alternative configuration of the invention, provision is made that the mounting interface is formed by a side of a mounting plate, at least one of the vacuum pump and the degassing component being attached to the mounting plate. This embodiment is based on the fundamental idea of shifting the mounting interface into a separate component, more specifically the mounting plate, which allows both a higher flexibility and the integration of further components into the degassing module.

Provision is preferably made that the vacuum pump includes a delivery outlet located at the mounting interface. A separate connection for the vacuum pump is therefore not necessary; when the degassing module is mounted to an analysis module, for example, the delivery outlet is automatically suitably connected.

According to one configuration of the invention, provision is made that the degassing component includes a silicone hose which is arranged in a vacuum chamber. A silicone hose is a very inexpensive part which can be used for degassing a large variety of fluids in a suitable manner, such as drinking water, for example.

If it is intended to actively deliver the degassed fluid from the degassing module to an analysis module, for example, a fluid pump may be provided between the degassing component and the fluid outlet.

According to a preferred configuration of the invention, a tank is provided which is arranged between the fluid inlet and the degassing component. Various advantages can be achieved based on the tank. For one thing, the tank may function as a “buffer” when fluid from a pressurized system is to be analyzed. In this case, the fluid is introduced into the tank, and the tank is then disconnected from the fluid system. Subsequently, a pressure that is suitable for the degassing module, for example atmospheric pressure, may be established in the tank. The tank is also advantageous to the effect that different fluids are degassed and subsequently analyzed with relatively little effort, without a previously degassed fluid contaminating the fluid that is currently being degassed. For this purpose, the tank can be simply flushed so that any residues of the previously degassed fluid are removed.

Preferably, a shut-off valve is provided between the fluid inlet and the tank. The shut-off valve can be used for separating the tank with little effort from the pressure of a fluid system that is connected via the fluid inlet.

Preferably, provision is also made that the tank includes a tank outlet which has a switching valve associated with it. The tank outlet allows the tank to be flushed or rinsed in order to prevent that a fluid to be currently analyzed is contaminated by a fluid analyzed earlier.

The tank outlet is preferably arranged in an upper section of the tank. This allows the tank outlet to be used also for discharging any gas that has separated within the tank from the fluid contained therein.

The switching valve is adapted to connect the tank outlet with a fluid drain which is preferably positioned at the mounting interface. As a result, the fluid drain does also not require a separate, external connection at the degassing module,

The vent may include an atmospheric connection and a discharge outlet. A fluid may be discharged via the discharge outlet, for example, while the tank is flushed. The atmospheric connection may serve to admit air into the tank in order to set the tank at an atmospheric pressure.

According to a further configuration of the invention, a change-over valve is provided which allows venting via one of the atmospheric connection and the discharge outlet. The change-over valve is adapted to connect the tank outlet to the atmospheric connection or the discharge outlet, depending on the operating condition.

Provision may be made here that at least one of the atmospheric connection and the discharge outlet is provided at the mounting interface. In this case, too, any external connections at the degassing module are not necessary.

Preferably, an integrated control electronics is provided which can be connected by means of a plug connection. The degassing module is therefore an “autarkic” module which, except for a control line which may also be used for a power supply to the vacuum pump, for example, requires no external connections or lines whatsoever since the other connections are all integrated in the mounting interface.

Advantageous further configurations of the invention will be apparent from the dependent claims.

### BRIEF DESCRIPTION OF THE DRAWINGS

FIG. 1 shows a perspective view of a degassing module according to a first embodiment of the invention;

FIG. 2 shows a second perspective view of the degassing module of FIG. 1;

FIG. 3 shows a top view of the degassing module of FIG. 1;

FIG. 4 shows a schematic bottom view of the degassing module of FIG. 1;

FIG. 5 shows a schematic illustration of the degassing module of FIG. 1;

FIGS. 6a to 6c show one option for connecting a vacuum pump to the degassing component of the degassing module of FIG. 1;

FIG. 7 shows a schematic view of a degassing module according to a second embodiment of the invention;

FIG. 8 shows a second perspective view of the degassing module of FIG. 7;

FIG. 9 shows a top view of the degassing module of FIG. 7;

FIG. 10 shows a perspective bottom view of the degassing module of FIG. 7;

FIGS. 11a to 11d show details of a mounting plate used in the degassing module of FIG. 7;

FIG. 12 shows a schematic circuit diagram of the degassing module according to the second embodiment;

FIG. 13 schematically shows a first method step in the operation of the degassing module according to the second embodiment;

FIG. 14 schematically shows a second method step;

FIG. 15 schematically shows a third method step; and

FIG. 16 schematically shows a fourth method step in the operation of the degassing module according to the second embodiment.

### DESCRIPTION OF THE INVENTION

The invention will be described below with reference to various embodiments which are illustrated in the accompanying drawings.

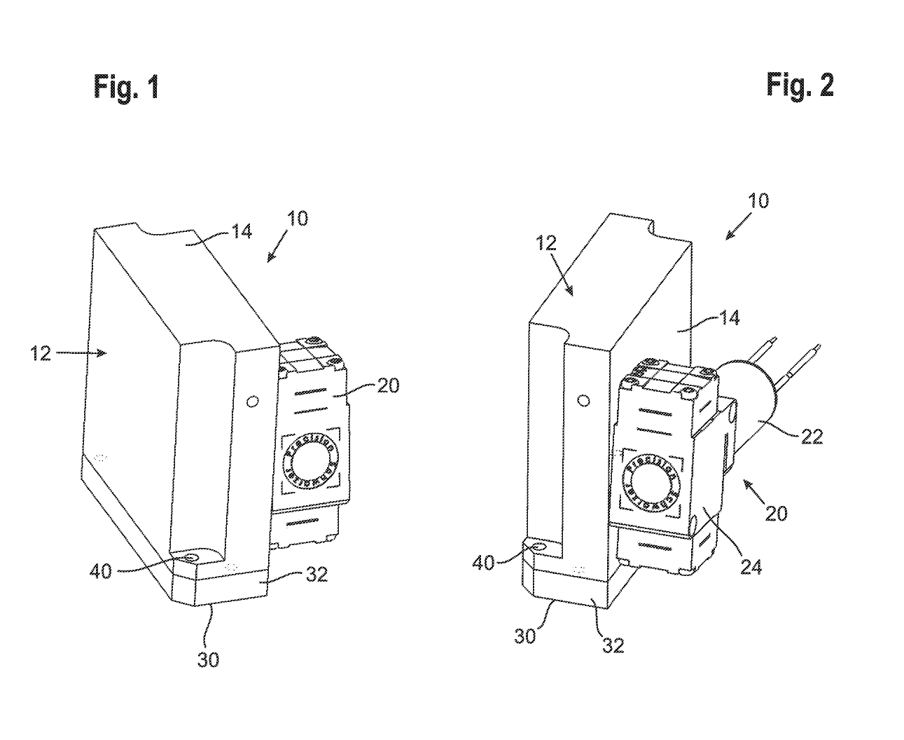

FIGS. 1 to 4 show a degassing module 10 according to a first embodiment.

The essential parts contained in the degassing module 10 are a degassing component 12 and a vacuum pump 20.

The degassing component 12 includes a housing 14 in which a vacuum chamber 16 is defined. Arranged within the vacuum chamber 16 is a diaphragm 18 which here is in the form of a hose made from silicone. When a fluid flows through the hose 18 and a vacuum is applied to the vacuum chamber 16 by means of the vacuum pump 20, the fluid flowing through the hose 18 is degassed in a manner known per se.

The vacuum pump 20 includes a motor 22 and a pump head 24. The pump head 24 is attached directly to the housing 14 of the degassing component 12, for example bolted to it. The ports of the vacuum pump 20 are thereby also directly connected to suitable openings in the housing 14 of the degassing component 12 without any external hose lines or other connections being necessary.

Suitable sealing means, such as O-rings, for example, are arranged between the pump head and the housing.

The degassing module 10 is configured with a mounting interface 30 which here is in the form of the underside of a mounting plate 32.

The mounting interface 30 here has a fluid inlet 34 and a fluid outlet 36 integrated therein, which are formed as openings in the mounting plate 32 which have a seal in the form of an O-ring 38 associated therewith. The fluid inlet 34 is tightly connected with an end of the hose 18 arranged in the vacuum chamber 16 and the fluid outlet 36 is connected with the second end of the hose 18. The degassing module 10 can thus be fluidically connected in that the mounting plate 32 is mounted to an appropriately configured counter-piece that is provided with openings for supplying and/or discharging the fluid to be degassed. Since the vacuum pump 20 is firmly attached to the degassing component 12, it need not be separately mounted and fluidically connected.

For attachment of the mounting plate 32, it is provided with a plurality of fastening openings 40 through which suitable fastening bolts can be fitted.

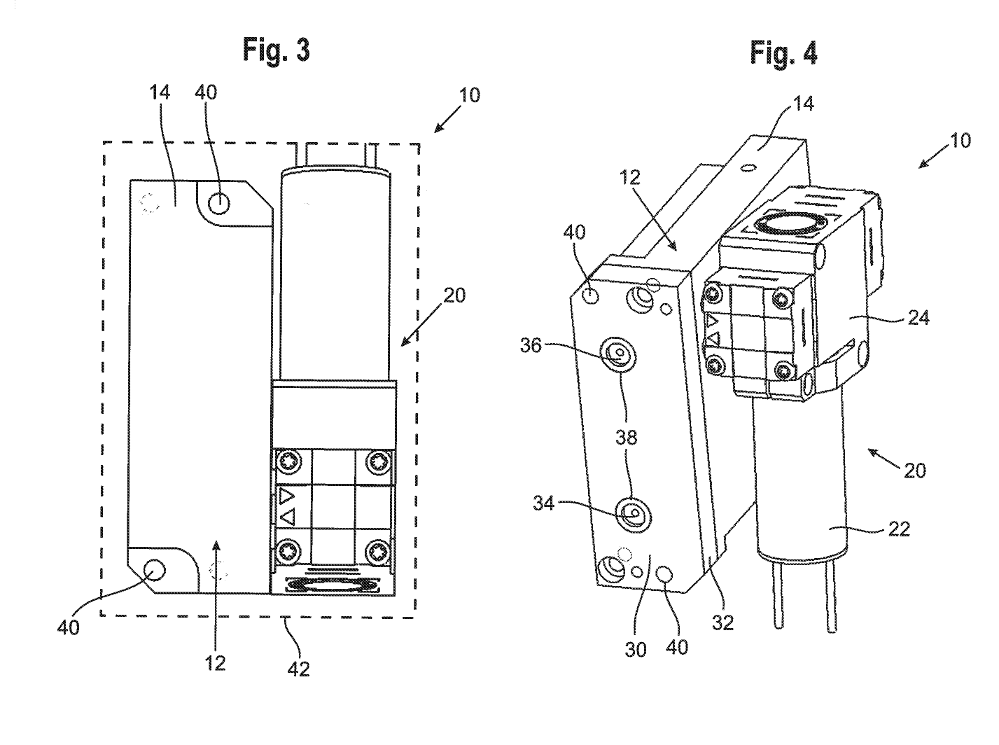

The degassing module 10 may also be provided with a housing 42 indicated schematically in FIG. 3, so that it is protected from environmental influences. In this case, the housing 42 is preferably provided with a plug connection (not shown here) for electrically connecting the vacuum pump 20.

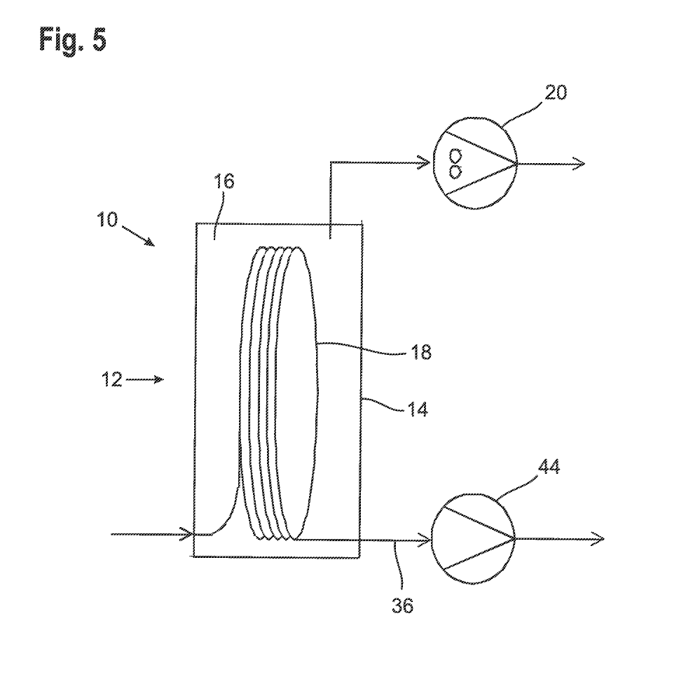

Optionally, the degassing module 10 may also be provided with a fluid pump 44 (see FIG. 5) which pumps the degassed fluid out of the degassing module.

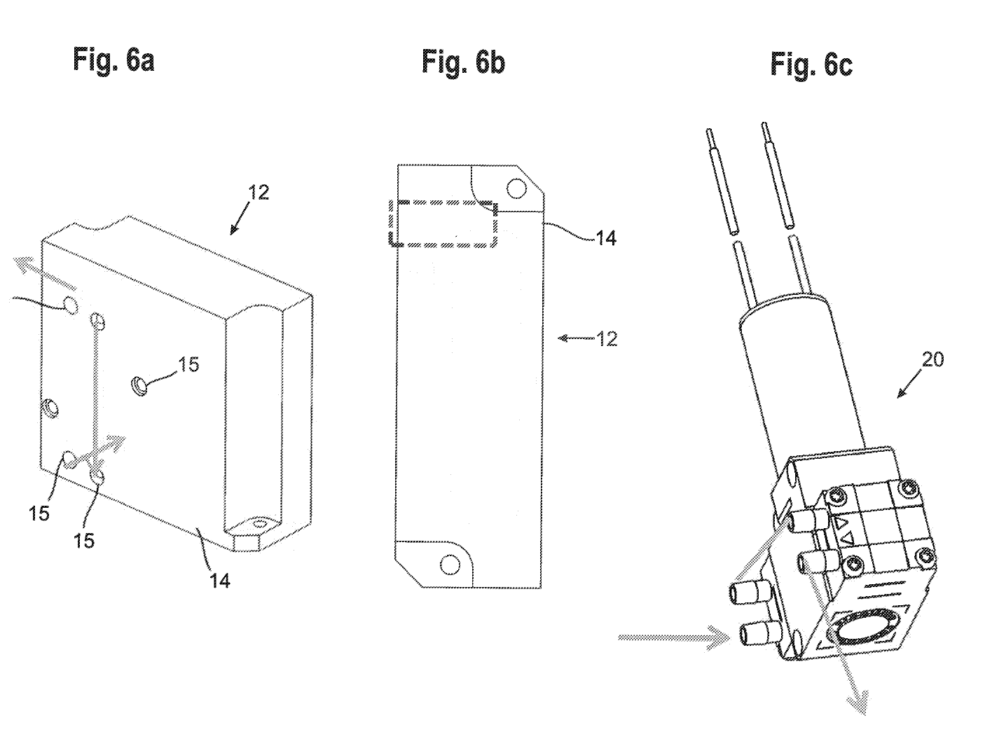

FIGS. 6a to 6c schematically show a variant embodiment in which a two-stage vacuum pump 20 is used the two stages of which are connected in a series connection to the vacuum chamber 16 of the housing 14 of the degassing component 12 in order to obtain a higher pump delivery rate. In FIG. 6a, the corresponding openings 15 in the side wall of the housing 14 of the degassing component 12 are well visible, by which the vacuum pump 20 is directly connected to the vacuum chamber 16.

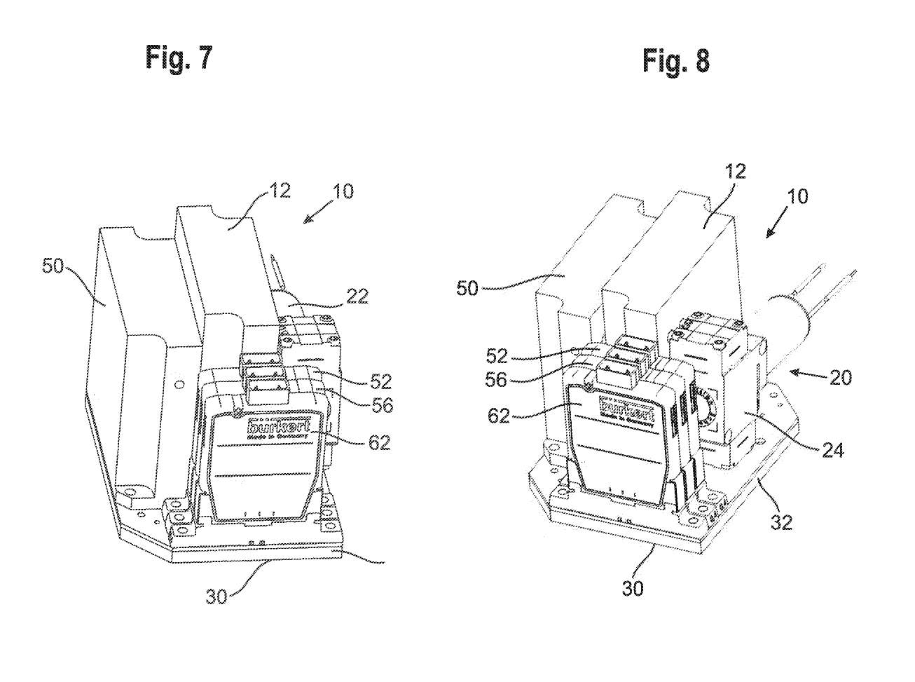

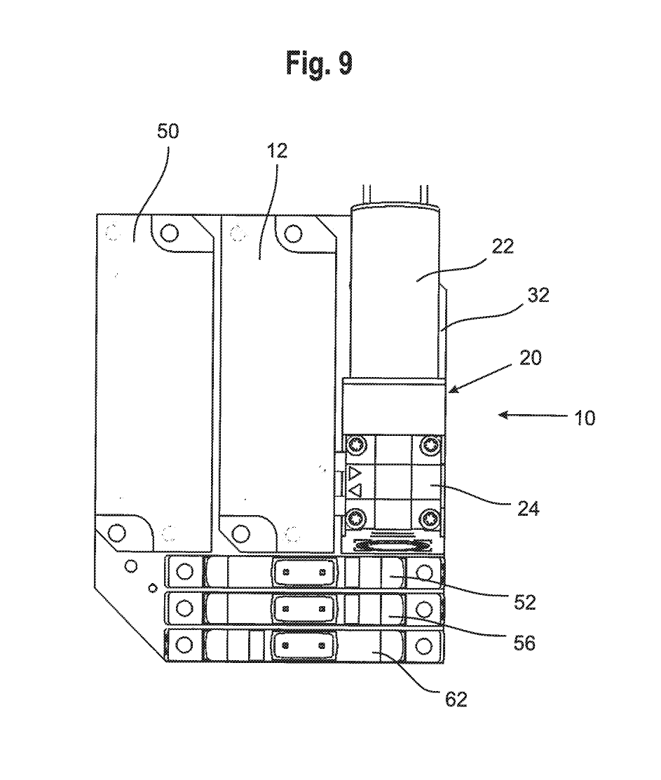

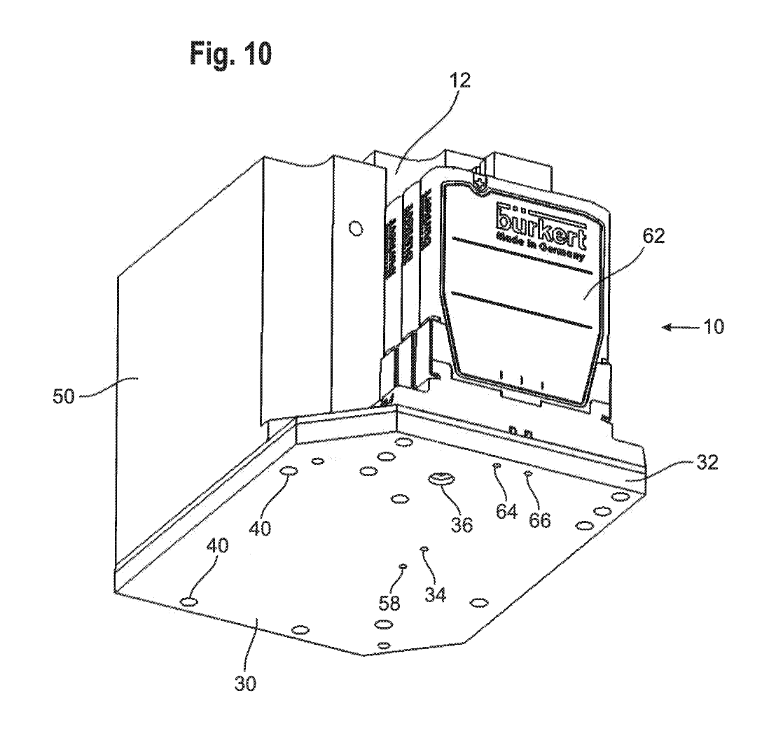

FIGS. 7 to 11 show a degassing module 10 according to a second embodiment. The same reference numerals are used for the components known from the first embodiment, and reference is made to the above discussions in this respect.

The essential difference between the first and second embodiments consists in that in the second embodiment a tank 50 is provided between the fluid inlet 34 and the degassing component 12. The tank 50 is of advantage in particular if the degassing module 10 is to be connected to a system under an inlet pressure. One example is a drinking water supply system from which drinking water is to be taken and analyzed at regular intervals.

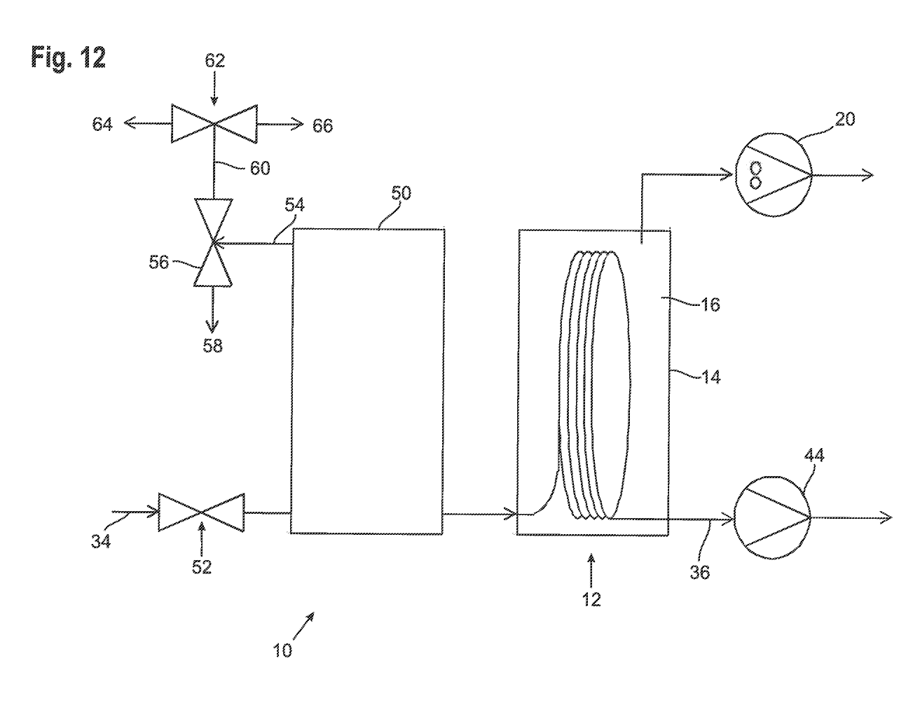

The structure of the degassing module according to the second embodiment will now be described below with reference to FIG. 12. The fluid inlet 34 has a shut-off valve 52 associated therewith which, in the opened state, allows that fluid can flow from the fluid inlet 34 into the tank 50. In the closed state, a pressure-tight shut-off is ensured. The tank 50 includes a tank outlet 54 that is connected with the tank 50 in an upper section of the tank. The tank outlet 54 has a switching valve 56 associated with it which is preferably in the form of a 3/2-way valve. One of the outlets of the switching valve 56 leads to a fluid drain 58 and the other outlet of the switching valve 56 leads to a vent 60.

The vent has a change-over valve 62 provided thereon which is formed as a 3/2-way valve here. Depending on its switching position, it connects the vent 60 either with an atmospheric connection 64 or with a discharge outlet 66.

Also in the second embodiment, the various connections of the degassing module 10 are placed in the mounting interface 30, that is, at the underside of the mounting plate 32 here. The mounting plate is provided with both the fluid inlet 34 and the fluid outlet 36 as well as with the fluid drain 58, the atmospheric connection 64 and also the discharge outlet 66.

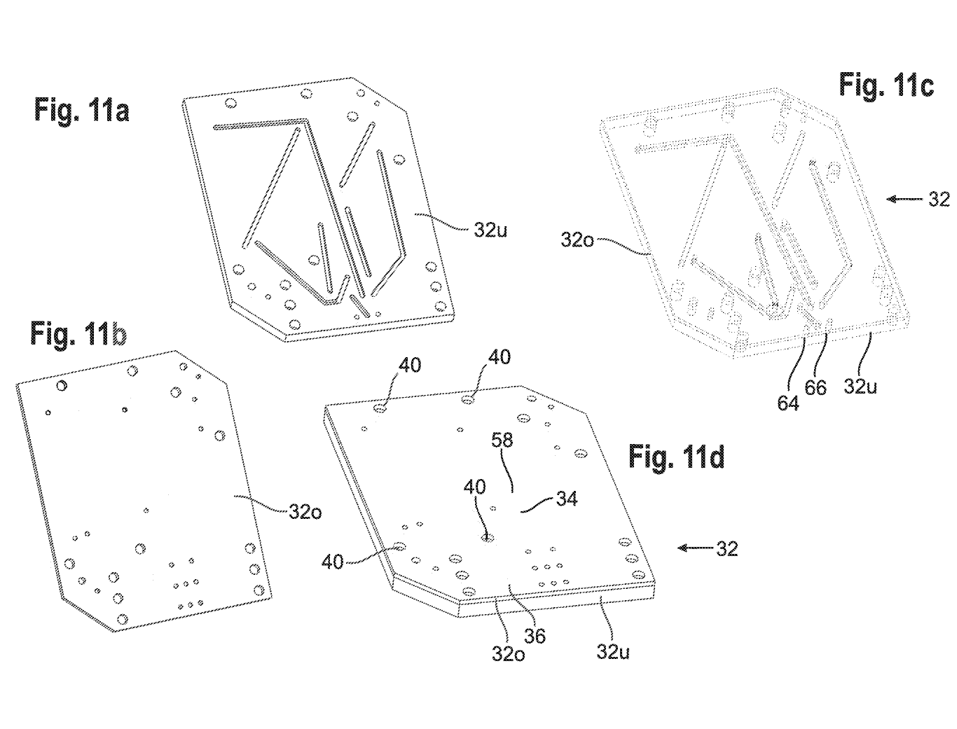

As can be seen in FIGS. 11a to 11d, the mounting plate 32 is provided with the fluid ducts and connections required therefor. For an easier manufacture, the mounting plate 32 is in the form of a composite part here, consisting of a lower part 32u and an upper part 32o. Provided in the lower part 32u are the various duct structures and openings towards the mounting interface 30 while the upper part 32o is arranged as a cover on the lower part, which is formed with the openings upwards to the various valves and other components. The upper part and the lower part are connected with each other in a fluid-tight manner, for example adhesively bonded or welded face-to-face.

The degassing module 10 according to the second embodiment may be used in the following way:

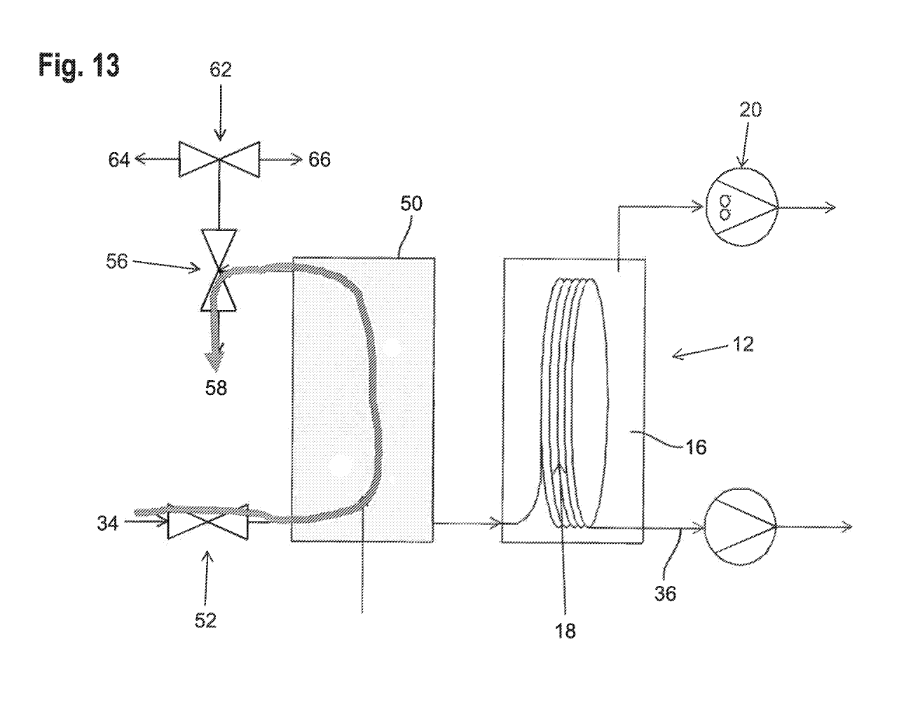

In a first step (see FIG. 13), the shut-off valve 52 is opened and the switching valve 56 is switched such as to connect the tank outlet 54 with the fluid drain 58. This causes the tank 50 to be flushed with fresh fluid, that is, the fluid which subsequently is to be degassed and then analyzed. This condition is maintained until such time as the tank 50 has been completely flushed (that is, the fluid previously contained therein has been completely washed out) and the tank 50 is filled with the fluid to be currently analyzed.

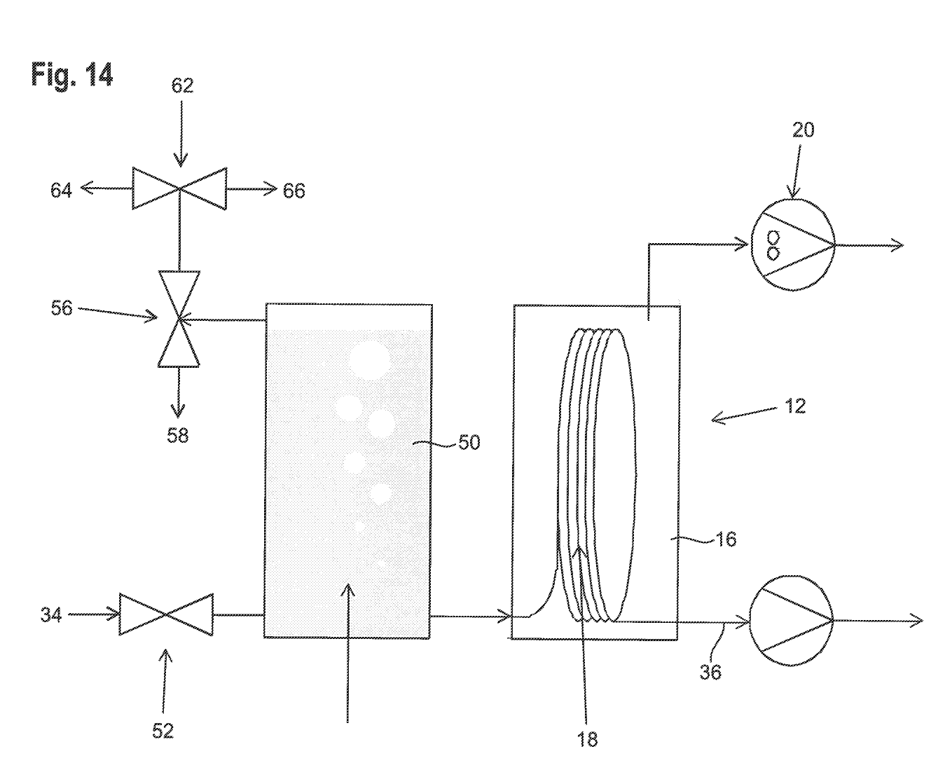

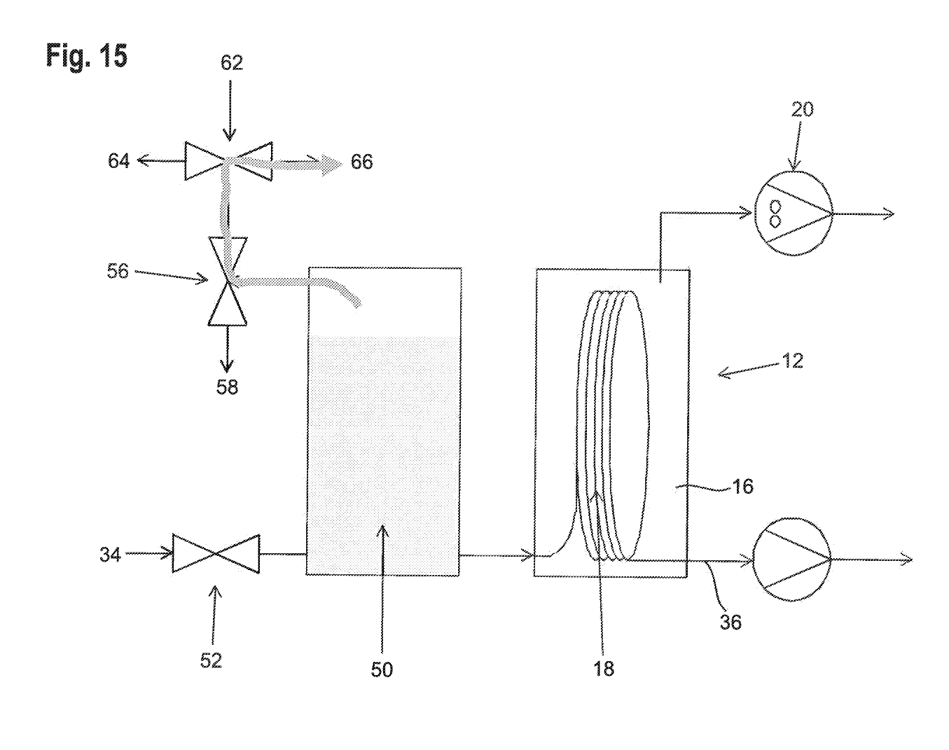

In a second step, the shut-off valve 52 is dosed so that the inlet pressure of the fluid system to which the degassing module is connected is separated. In addition, the switching valve 56 may be dosed. In this state (see FIG. 14), part of the gas that is contained in the fluid in the tank 50 can outgas. These gas portions may either be gas bubbles which were introduced into the tank 50 directly through the fluid inlet 34 or in the form of gas portions dissolved in the fluid. It is also possible for gas portions to dissolve in that the fluid heats up in the tank 50 and thereby outgases.

The gas portions accumulating in the upper part of the tank 50 are discharged via the tank outlet 54 by the switching valve 56 connecting the tank outlet 54 with the vent 60.

In the embodiment shown, the vent 60 is provided with a change-over valve 62 which in the switching position towards the discharge outlet 66 serves to vent the tank outlet 54 with a controlled pressure drop. As soon as the pressure in the tank 50 is at atmospheric level, the change-over valve 62 can be changed over such as to connect the tank outlet 54 with the atmospheric connection 64.

If the fluid drain 58 is at atmospheric pressure and therefore the tank 50, after having been filled, is also at atmospheric pressure, the change-over valve 62 and the discharge outlet 66 may be dispensed with; the tank outlet 54 may then be connected directly with the atmospheric connection 64 when the switching valve 56 is opened, without a pressure surge being produced which would cause certain amounts of fluid to be ejected from the tank 50.

When the tank 50 is at atmospheric pressure (see FIG. 16), the fluid in the tank 50 can be delivered through the degassing component 12 and from there to the fluid outlet 36. In the process, the fluid is further degassed in the degassing component 12.

In case small gas bubbles develop on the inner wall of the tank 50 or remain adhered there, this in noncritical since the connection between the tank 50 and the degassing component 12 is arranged in the lower portion of the tank 50. The gas bubbles will therefore not move into the system, but are eliminated by means of the decreasing fluid level.

A control electronics (not shown here) may also be integrated into the degassing module 10, so that the entire degassing module 10 can be driven via one single plug. The control electronics can make sure that the various valves 52, 56, 62 are opened and closed in a suitable manner for suitably filling the tank 50 prior to each fluid analysis.

1. A degassing module comprising a fluid inlet, a degassing component comprising a vacuum chamber, a fluid outlet, a vacuum pump, and optionally a fluid pump arranged between the degassing component and the fluid outlet, wherein the degassing component and the vacuum pump are integrated to form a unit which includes a mounting interface at which the fluid inlet and the fluid outlet are positioned, wherein the vacuum pump optionally includes a delivery outlet located at the mounting interface, wherein the mounting interface is formed by a side face of a housing of the degassing component or a side of a mounting plate with at least one of the vacuum pump and the degassing component being attached to the mounting plate, which degassing module optionally comprises an integrated control electronics which can be connected by means of a plug connection.

2. The degassing module according to claim 1, wherein the mounting interface is formed by a side face of a housing of the degassing component and the vacuum pump is attached to the degassing component.

3. The degassing module according to claim 1, wherein the mounting interface is formed by a side of a mounting plate, at least one of the vacuum pump and the degassing component being attached to the mounting plate.

4. The degassing module according to claim 1, wherein the vacuum pump includes a delivery outlet that is located at the mounting interface.

5. The degassing module according to claim 1, wherein the vacuum chamber comprises a silicone hose arranged therein.

6. The degassing module according to claim 1, wherein a fluid pump is provided which is arranged between the degassing component and the fluid outlet.

7. The degassing module according to claim 1, wherein a tank is provided which is arranged between the fluid inlet and the degassing component.

8. The degassing module according to claim 7, wherein a shut-off valve is provided between the fluid inlet and the tank.

9. The degassing module according to claim 7, wherein the tank includes a tank outlet which has a switching valve associated with it.

10. The degassing module according to claim, 9 wherein the tank outlet is arranged in an upper section of the tank.

11. The degassing module according to claim 9, wherein the switching valve is adapted to connect the tank outlet with a fluid drain and/or a vent.

12. The degassing module according to claim 11, wherein the fluid drain is located at the mounting interface.

13. The degassing module according to claim 11, wherein the vent includes an atmospheric connection, a discharge outlet and a change-over valve which allows venting via one of the atmospheric connection and the discharge outlet.

14. The degassing module according to claim 13, wherein the fluid drain and/or at least one of the atmospheric connection and the discharge outlet is provided at the mounting interface.

15. The degassing module according to claim 8, wherein the tank includes a tank outlet which has a switching valve associated with it.

16. The degassing module according to claim, 15 wherein the tank outlet is arranged in an upper section of the tank.

17. The degassing module according to claim 15, wherein the switching valve is adapted to connect the tank outlet with a fluid drain and/or a vent, wherein said vent comprises an atmospheric connection, a discharge outlet and a change-over valve that allows venting via one of the atmospheric connection and the discharge outlet.

18. The degassing module according to claim 17, wherein the fluid drain and/or at least one of the atmospheric connection and the discharge outlet is provided at the mounting interface.

19. The degassing module according to claim 7, characterized in that a fluid pump is provided which is arranged between the degassing component and the fluid outlet.

20. The degassing module according to claim 15, wherein a fluid pump is provided which is arranged between the degassing component and the fluid outlet.

21. The degassing module according to claim 17, wherein a fluid pump is provided which is arranged between the degassing component and the fluid outlet.

22. The degassing module according to claim 18, wherein a fluid pump is provided which is arranged between the degassing component and the fluid outlet.
